(19) United States
(12) Patent Application Publication
(10) Pub. No.: US 2015/0369756 A1
(43) Pub. Date: Dec. 24, 2015

(54) SCANNING APPARATUS

(71) Applicant: Manchester Metropolitan University, Manchester (GB)

(72) Inventors: Nacer Ddine Rezgui, Greater Manchester (GB); Nicholas Bowring, Derbyshire (GB); David Andrews, Cheshire (GB); Stuart Harmer, Manchester (GB); Matthew James Southgate, Cheshire (GB); Dean O'Reilly, Greater Manchester (GB)

(21) Appl. No.: 14/310,515

(22) Filed: Jun. 20, 2014

(51) Int. Cl. G01N 22/00

(52) U.S. Cl. CPC G01N 22/00

(57) ABSTRACT

A method of scanning a shoe. The method comprises directing from a source at least one first signal at the shoe, the at least one first signal comprising substantially millimetre and/or microwave radiation, receiving at one or more receivers a plurality of second signals, the plurality of second signals comprising reflections of the at least one first signal from different positions with the shoe. The method further comprises processing each of the second signals to determine a plurality of reflection positions within the shoe and processing the plurality of second signals and reflection positions to generate second data, the second data indicating a composition of the shoe.

The present invention relates to scanning methods and apparatus. The invention is particularly, but not exclusively, beneficial for scanning shoes in order to detect the presence of concealed objects such as explosives, weapons and contraband material.

### BACKGROUND OF THE INVENTION

Security checkpoints are often used at high risk locations (such as airports) to screen people and belongings in order to detect concealed objects. A heightened risk of terrorist attacks on the pubic has led to increased levels of security screening at security checkpoints. In an effort to detect concealed objects at security checkpoints, each person and their belongings may be individually screened. Screening may comprise a series of scanning techniques such as metal detection, x-ray back-scatter scanning and passive microwave imaging. Since the well publicised “shoe bomber” attack in 2001 there is an increased requirement to detect concealed objects in shoes. Many security checkpoints now require people to remove their shoes and any other items which might contain concealed objects. These items are then individually scanned. This procedure increases the time required to screen a person and their belongings, thus decreasing the throughput of security checks.

### SUMMARY OF THE INVENTION

It is an object of the present invention to obviate or mitigate one or more of the disadvantages of the prior art, whether identified herein, or elsewhere.

According to a first aspect of the present invention, there is provided a method of scanning a shoe, comprising: directing from a source at least one first signal at the shoe, the at least one first signal comprising substantially millimetre and/or microwave radiation; receiving at one or more receivers a plurality of second signals, the plurality of second signals comprising reflections of the at least one first signal from different positions with the shoe; processing each of the second signals to determine a plurality of reflection positions within the shoe; processing the plurality of second signals and reflection positions to generate second data, the second data indicating a composition of the shoe.

By calculating reflection positions of the second signals, the composition of a shoe may be advantageously determined. The composition of the shoe may indicate an internal structure of the shoe. The term millimetre and/or microwave radiation should be understood to generally include radiation in the frequency range of approximately 100 MHz-300 GHz.

The plurality of reflection positions may be a plurality of positions at different depths within the shoe. Where the second signals are received at more than one receiver, each receiver may receive respective a single signal, or may receive a plurality of signals. In some embodiments, a single first signal is directed by each of a plurality of sources with each first signal resulting in a respective second signal and each second signal being received by a respective receiver. Sources and receivers may be transceivers and each transceiver may receive a second signal corresponding to a first signal directed by that transceiver.

The method may further comprise processing the second data to generate an indication of whether the shoe comprises concealed material. The first aspect of the invention therefore provides a method for advantageously determining whether a shoe may comprise concealed material. The concealed material may be any type of concealed material, for example, explosive material, or an explosive device. As a further example, the concealed material may be a concealed weapon, contraband material such as money, drugs etc. As further examples, the concealed materials may be flammable materials, radioactive materials, explosive and/or flammable precursors or binaries, materials which are inert in isolation but which may be explosive or flammable when mixed or when coming into contact with other materials.

The method may further comprise processing the second data to generate an indication of a cushioning ability of the shoe. In this way, the first aspect provides a method for advantageously determining whether a shoe would provide an adequate level of cushioning, and/or optimizing performance and behaviour of the shoe. For example athletic, sporting or general performance/behaviour may be modeled based on the indication of cushioning ability.

Processing the second data may comprise comparing the second data to first reference data. For example, the first reference data may comprise data indicating a composition of a reference shoe. The reference shoe may be a shoe that does not comprise concealed material, such that a comparison between the shoe scanned by according to the first aspect, and the reference shoe, provides an indication as to whether the scanned shoe comprises concealed material. Alternatively, the reference shoe may be a shoe that does comprise concealed material.

Where the first aspect of the invention is used to determine a cushioning ability of the shoe, the first reference shoe may comprise a shoe with a known, desirable cushioning ability. A comparison with the reference shoe may therefore indicate a reduced, or undesirable cushioning ability of the scanned shoe.

Processing the second data may comprise scanning a second shoe to generate third data indicating a composition of the second shoe and comparing the second data with the third data. For example, a pair of shoes being worn by a person undergoing a security scan may be scanned according to the first aspect of the invention. The data generated by scanning each shoe in the pair may then be compared.

The method may further comprise outputting an indication that one of the first or second shoes comprises concealed material if the comparison indicates a difference in composition between the second and third shoes. In this way, a particularly efficient method of determining an indication of whether one the first or second shoes comprises concealed material is provided by performing a comparison of both of the first and second shoes, thereby removing the need for predefined reference data. In some aspects of the invention, a comparison between two shoes, and a comparison with reference data may be employed.

Processing the second data may comprise generating an image from the second data and outputting the image on a display device.

Directing at least one first signal at the shoe may comprise directing a pulse of radiation at the shoe. For example, the pulse of radiation may be an amplitude modulated single frequency sine wave.

Each of the second signals may be a reflection of a portion of the pulse and each of the second signals may be received at a different time.

Directing at least one first signal at the shoe may comprise directing radiation having a plurality of frequencies at the shoe such that the plurality of the second signals comprises radiation having a plurality of frequencies.

Generating the second data may comprise transforming the second signals into a time domain. That is, the second signals may be received in a frequency domain, and determining the plurality of reflection positions and generating the second data may comprise transforming the second signals from the frequency domain to the time domain. The transformation to the time domain may use, for example, an inverse Fourier transform, or a chirp transform.

Processing the second data may comprise applying the second data as input to a neural network.

Generating the plurality of second signals may comprise third signals, the third signals being reflections of the at least one first signal from a surface between the source and the shoe. Processing the plurality of second signals and reflection positions may comprise substantially removing the third signals from the second signals.

Removing the third signals may comprise subtracting a predetermined reference signal from the second signals.

The radiation may be directed at the shoe from beneath the shoe. The radiation may be directed at the shoe from a plurality of locations with respect to the shoe. For example, the source may be disposed on a carriage adapted to position the source at different positions with respect to the shoe.

The source may comprise, for example, a horn antenna. The or each of the one or more receivers may comprise one of a heterodyne receiver, a homodyne receiver, or a direct detection receiver.

According to a second aspect of the present invention, there is provided an apparatus for scanning a shoe, comprising: a source arranged to direct at least one first signal comprising substantially millimetre and/or microwave radiation at a shoe; one or more receivers arranged to receive a plurality of second signals comprising reflections of the at least one first signal from different positions with the shoe; a controller arranged to process each of the second signals to determine a plurality of reflection positions within the shoe and process the plurality of second signals and reflection positions to generate second data indicating a composition of the shoe.

The source may be mounted on a carriage arranged to move the source between a plurality of locations with respect to the shoe.

The apparatus may further comprise a surface for receipt of a shoe, the surface being substantially transparent to millimetre and/or microwave radiation.

The surface may comprise a plurality of slats, extending in a direction substantially parallel to a direction in which shoes are to be scanned.

The source may be a horn antenna.

The source may be positioned at a distance of 10 mm from said surface.

According to a third aspect of the present invention, there is provided a computer program comprising computer readable instructions arranged to cause a computer to carry out a method according to the first aspect.

According to a fourth aspect of the present invention, there is provided a carrier medium carrying a computer program according to the third aspect.

According to a fifth aspect of the present invention, there is provided a computer apparatus for scanning a shoe, comprising: a memory storing processor readable instructions; and a processor arranged to read and execute instructions stored in the memory; wherein the processor readable instructions comprise instructions arranged to control the computer to carry out a method according to the first aspect.

It will be appreciated that aspects of the present invention can be implemented in any convenient way including by way of suitable hardware and/or software. For example, a device arranged to implement the invention may be created using appropriate hardware components. That is, it will be appreciated that any method steps or aspects of the invention described herein may be implemented using suitable apparatus, and vice versa. Alternatively, a programmable device may be programmed to implement embodiments of the invention. The invention therefore also provides suitable computer programs for implementing aspects of the invention. Such computer programs can be carried on suitable carrier media including tangible carrier media (e.g. hard disks, CD ROMs and so on) and intangible carrier media such as communications signals.

One or more aspects or embodiments of the invention described herein may, where appropriate to one skilled in the art, be combined with any one or more other aspects or embodiments described herein, and/or with any one or more features described herein.

### BRIEF DESCRIPTION OF THE DRAWINGS

Specific embodiments of the invention will now be described by way of example only, with reference to the accompanying Figures in which:

FIG. 1 is a schematic illustration of a side view of a shoe scanner according to an embodiment of the invention;

FIG. 2 is a schematic illustration of the shoe scanner of FIG. 1 viewed from above;

FIG. 3 is a schematic illustration of a control unit according to an embodiment of the invention;

FIG. 4 is a flow chart describing a method of shoe scanning according to an embodiment of the invention;

FIG. 5 is a flow chart describing a method of performing step 3 of FIG. 4;

FIG. 6 is a flow chart describing a method of performing step 4 of FIG. 4;

FIG. 7 is a flow chart describing a method of performing step 7 of FIG. 4;

FIG. 8 is a flow chart describing a method of performing step 8 of FIG. 4;

FIGS. 9a and 9b are images produced by scanning a pair of shoes in accordance with an embodiment of the invention;

FIG. 10a is a photograph of a shoe;

FIG. 10b is a photograph of the shoe of FIG. 9a with an imitation explosive material inserted into the heel of the shoe;

FIG. 10c is an image produced by scanning the shoe shown in FIGS. 9a and 9b, before an imitation explosive material was inserted into the shoe, according to an embodiment of the invention;

FIG. 10d is an image produced by scanning the shoe of FIGS. 9a and 9b, after an imitation explosive material was inserted into the shoe, according to an embodiment of the invention;

FIG. 11a is a photograph of a pair of shoes, with the right shoe dissembled and concealed objects inserted into the right shoe;

FIG. 11b is an image produced by scanning the right shoe of FIG. 10a according to an embodiment of the invention;

FIG. 11c is an image produced by scanning the left shoe of FIG. 10a according to an embodiment of the invention;

FIGS. 12a and 12b are images produced by scanning sports shoes, which have been worn for a period of months, according to an embodiment of the invention;

FIGS. 12c and 12d are images produced by scanning unworn sports shoes according to an embodiment of the invention; and

FIG. 13 is a schematic illustration of a portion of a shoe scanner according to an embodiment of the invention having two antennas.

### DETAILED DESCRIPTION OF THE INVENTION

The present invention is generally concerned with a shoe scanner for the detection of concealed objects, both metallic and non-metallic. In particular, the shoe scanner of the present invention advantageously detects concealed weapons, explosives and contraband materials (such as narcotics),by measuring how the material composition of a shoe changes with depth, in order to identify changes in material which may indicate the presence of concealed objects. Scanning a shoe may directly detect the presence of concealed objects or may alternatively detect suspicious shoes which require further inspection or scanning, for example manual inspection, x-ray scanning, etc.

Shoes are typically constructed mostly from dielectric materials. Microwave and/or millimetre wave electromagnetic radiation (such as radiation in the frequency range 100 MHz-300 GHz) is able to penetrate dielectric materials commonly used in shoes and is therefore suitable for use in scanning shoes. It is therefore possible to identify changes in material composition and measure dimensions of objects within shoes through analysis of the reflection of microwave and/or millimetre wave radiation. It is also possible to produce an image of the inner structure of a shoe by exposing it to microwave and/or millimetre wave radiation and measuring the reflected radiation.

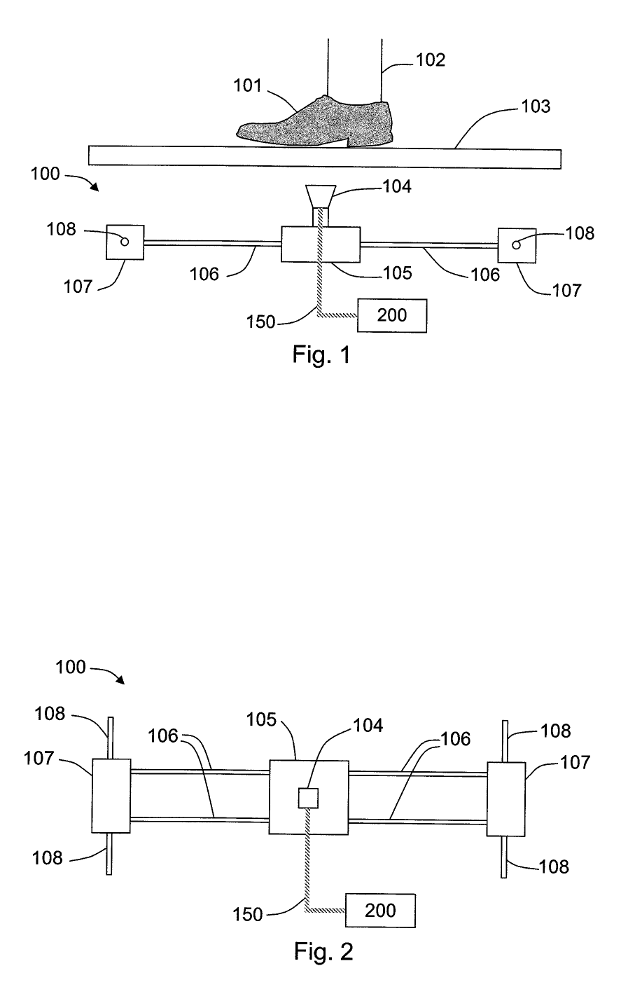

FIG. 1 schematically depicts a shoe scanner 100 according to an embodiment of the invention. Shoe scanner 100 is positioned beneath a surface 103 on which is placed a shoe 101 to be scanned. Surface 103 may be, for example, a prescribed portion of a floor on which a person places a foot (or feet), wearing a shoe (or shoes) to be scanned. Surface 103 preferably comprises a material which is substantially transparent to microwave and/or millimetre wave radiation, and may, for example, comprise a sheet of plastic material such as nylon or a metal grill. The surface 103 may comprise slats aligned parallel to the direction in shoes are to be scanned. Surface 103 may have marked on it a location at which a person should place their foot whilst wearing a shoe to be scanned. For example, to increase the throughput of a security checkpoint, the shoe scanner 100 may scan the shoe worn by a person 102 while the person 102 is scanned by some other means (e.g. a body scanner).

FIG. 2 schematically depicts the shoe scanner 100 as viewed from above. Shoe scanner 100 comprises a horn antenna 104 mounted on a carriage 105. In other embodiments, the antenna 104 need not be a horn antenna but may take any appropriate form. The carriage 105 travels smoothly along tracks 106 which may each comprise bars or rods. Tracks 106 are connected to end carriages 107 which travel smoothly along tracks 108. Tracks 108 may also comprise bars or rods and are positioned perpendicular to tracks 106. Movement of carriage 105 along tracks 106 and movement of end carriages 107 along tracks 108 may be facilitated by one or more belt drives connected to one or more pulleys mounted on one or more electric motors (not shown). Carriage 105 is selectively moved along tracks 106 in order to move the antenna 104 along the length of the shoe 101. End carriages 107 are selectively moved along tracks 108 in order to move the antenna 104 across the width of the shoe 101. That is, both the carriage 105 and the tracks 106 are moved laterally by the movement of end carriages 107. Alternative means may be employed to selectively move the antenna 104 along the length and across the width of the shoe 101. For example, the horn may be mounted on one or more lever arms (not shown) which rotate about axes parallel to the axis of the horn. Movement of the antenna 104 may be continuous or the antenna 104 may be moved in a series of steps.

In order to improve the spatial resolution of the shoe scanner 100, the antenna 104 is preferably positioned within close proximity to the underside of the surface 103. In some embodiments, the antenna 104 is positioned within 10 mm off the underside of the surface 103. In general, the distance between the antenna 104 and the underside of the surface 103 remains substantially constant while the antenna 104 is moved along the length and across the width of shoe 101.

The antenna 104 is connected to a control unit 200 via a connection 150. The control unit 105 may move with the antenna 104 on carriage 105. Alternatively the control unit 105 may be stationary and the connection 150 may be a flexible cable or any other connection means which allows the control unit 200 and antenna 104 to move relative to each other while maintaining the connection 150.

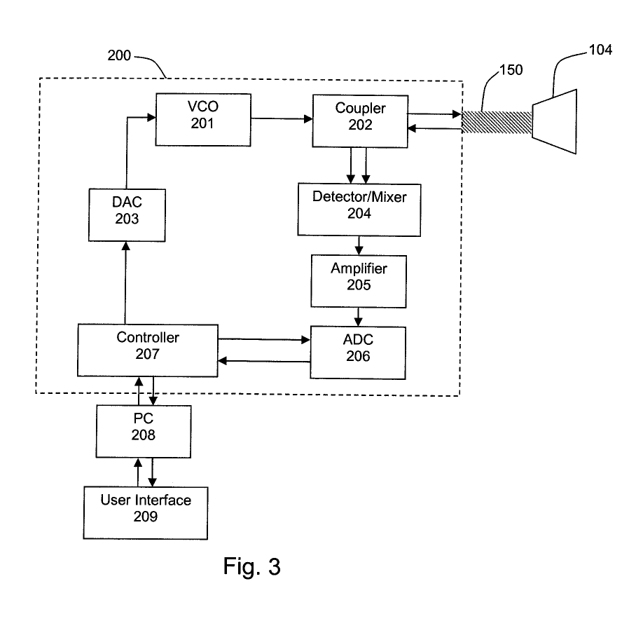

FIG. 3 schematically depicts control unit 200 in more detail. A voltage controlled oscillator 201 supplies an electric current, which forms a source signal having an amplitude, frequency and phase, to antenna 104. Antenna 104 emits electromagnetic radiation with an amplitude, frequency and phase corresponding to the amplitude, frequency and phase of the source signal. The frequency of the source signal is preferably such that the electromagnetic radiation is microwave and/or millimetre wave radiation.

The voltage controlled oscillator 201 is a free-running oscillator controlled by a voltage level supplied from a digital to analogue converter 203. This allows for the frequency of the source signal and the subsequently emitted radiation to be swept quickly and accurately. In some embodiments, the frequency of the source signal and emitted radiation may be controlled more accurately by phase-locking the output of the voltage-controlled oscillator 201 to harmonics of a reference crystal controlled oscillator (not shown). In order to increase the range of frequencies over which the source signal and emitted radiation may be swept, frequency multiplier modules (not shown) may be provided in between the voltage controlled oscillator 201 and the antenna 104. In some embodiments, more than one oscillator, with different operating frequency ranges, may be provided and the source signal supplied to the antenna 104 may then be switched between oscillators to change the frequency range of the source signal.

The antenna 104 also receives radiation reflected from objects placed in the path of the emitted radiation, the antenna 104 converting the received radiation to an oscillatory voltage signal, the oscillatory voltage signal forming a received signal. The received signal has an amplitude, frequency and phase corresponding to the amplitude, frequency and phase of the received radiation. The received signal is mixed or coupled with the source signal at a detector/mixer 204 to form a detection signal. The detection signal is a function of the amplitude, frequency and phase of the received signal relative to the amplitude, frequency and phase of the source signal. The detection signal therefore contains information about the reflection of the emitted radiation by the shoe 101. By processing detection signals at different times or frequencies, the relative power of radiation reflected from different depths in the shoe 101 can be resolved. The relative power of radiation reflected from different depths in the shoe 101 can be used to infer the material construction of the shoe 101, and to discern possible abnormalities in the material construction of the shoe 101, such as those resulting from concealed objects within the shoe 101.

In some embodiments of the invention, simpler detectors may be used wherein the detection signal is based on the amplitude, but not the phase, of the received signal. In such embodiments, interference between different reflecting components at different depths of the shoe 101 provides information about the relative position of those reflecting components.

In the embodiment of the invention depicted in FIG. 3, the detection signal is formed by first coupling the received signal and the source signal on a coupler 202. The outputs of coupler 202 are then mixed by the detector/mixer 204. Coupler 202 may be, for example, a directional coupler or a magic tee coupler. Coupler 202 may comprise a combination of more than one coupler.

In other embodiments of the invention, the source signal is amplified, and/or leveled, and input as a reference signal to the detector/mixer 204. The received signal is also input to the detector/mixer 204. The detector/mixer 204 may be, for example, a microwave mixer. The detector/mixer 204 may be a sub-harmonic mixer (particularly if a frequency multiplier module is used in forming the source signal).

The detection signal is amplified by an amplifier 205 to make the detection signal more suitable for producing a digital measurement of the detection signal by an analogue to digital converter 206. Conversion of the detection signal to a digital measurement may be performed at a time which is synchronised with changes in the frequency of the source signal. For example, the frequency of the source signal may first be changed and the detection signal then converted to a digital measurement corresponding to the new frequency of the source signal. Conversion of the detection signal to a digital measurement may occur at one or more times for each frequency of the source signal.

Changes to the source signal and conversion of the detection signal to a digital measurement is controlled by a controller 207, which may be an electronic control unit or a micro-computer. Digital measurements are relayed to a computer 208, which may be a personal computer or may be a computer imbedded within the controller 207. The computer 208 can be used by an operator of the shoe scanner 100 to control the source signal and/or the position of the antenna 104. The computer 208 may also be networked with other scanning systems to facilitate simultaneous operation. Digital measurements are displayed to an operator via a user interface 209. The user interface 209 can also be used to input instructions to control the shoe scanner 100.

Methods and apparatus for forming a measurement of received radiation as a function of emitted radiation according to the invention should not be understood to be limited to those described above. Any system may be used which forms and measures a detection signal which is a function of the amplitude, frequency and phase of the received signal relative to the source signal. Methods and apparatus for forming a detection signal may include superheterodyne mixing with a local oscillator. According to an embodiment of the invention a linearly polarised waveguide horn antenna is controlled by an Agilent E8363B vector network analyser (VNA) which comprises all of the components of the controller 200 shown in FIG. 3.

In general, during use, at each position of the antenna 104 radiation is emitted and detection signals are measured. The detection signals are later processed by the computer 208 in order to construct an image of the magnitude of the detection signals reflected from materials at different depths within the shoe 101.

To construct an image of the signals reflected from different depths within the shoe 101, the radiation may be emitted in pulses and the time delay between the emission of a radiation pulse and the measurement of a detection signal stored. That is, for each position of the antenna 104, the time delays at which detection signals are measured forms a time domain. A time delay between emitting radiation and measuring a detection signal can be used to resolve the depth in the shoe from which the radiation was reflected.

Alternatively, the frequency of emitted radiation may be swept across a wide frequency range and detection signals measured at each frequency. That is, for each position of the antenna 102, the frequencies at which the detection signals are measured forms a frequency domain. Detection signals in the frequency domain are then transformed into the time domain. Transformation of the detection signals in the frequency domain to detection signals in the time domain may be by way of an inverse Fourier transform or a chirp transform. Detection signals in the time domain are used, as if they were measured in the time domain, to resolve the detection signal reflected from different depths within the shoe.

The signal reflected from different depths within a shoe is dependent on the dielectric properties of the shoe. Changes in the dielectric properties within a shoe may cause interference effects between radiation which has been reflected from different depths within the shoe. Interference effects manifest themselves in detection signals both in the frequency domain (as changes in the detection signal at respective frequencies) and in the time domain (as changes in the detection signal at different times after a radiation pulse). It can therefore be considered that the structure of dielectric properties of a shoe are encoded in the reflectivity of the shoe Γ(ν) as a function of frequency ν.

If the emitted radiation is approximately planar to the sole of a shoe then the detection signal in the frequency domain S(ν) may be given by equation (1),

$$S ( v ) = A ( v ) Γ ( v ) exp ( - i \frac{4 π v}{c} {z}_{0} ) \qquad ( 1 )$$

where c is the speed of light, z₀ is the distance between the antenna 104 and the sole of the shoe 101 and A(ν) is the antenna response. The antenna 104 has a finite frequency range over which it transmits and receives radiation. Within this frequency range, the antenna 104 applies filtering (as a function of frequency) to the signals emitted and detected by the antenna 104. The effects of antenna filtering can be expressed as an antenna response term A(ν). If A(ν) is not constant at all frequencies of operation then a detection signal is a filtered version of the reflectivity Γ(ν) of a shoe.

A signal detected at an antenna may be expressed in the time domain as,

$$S ( t ) = {}^{- 1} \{ A ( v ) Γ ( v ) exp ( - i \frac{4 π v}{c} {z}_{0} ) \} \qquad ( 2 )$$

where ℑ⁻¹ is the inverse Fourier transform operation. By using the convolution theorem, the signal received at the antenna 104 in the time domain may be rewritten as,

$$S ( t ) = \frac{1}{2 π} {}^{- 1} \{ A ( v ) \} ⊗ {}^{- 1} \{ Γ ( v ) \} ⊗ δ ( t - \frac{2 {z}_{0}}{c} ) \qquad ( 3 )$$

where \textcircled{×} represents the convolution operation and the term

$$δ ( t - \frac{2 {z}_{0}}{c} )$$

(where δ is the Dirac delta function) serves to shift the time domain by the time taken for radiation to travel from the antenna 104 to the sole of a shoe and back again.

In general, the reflectivity Γ(ν) of a shoe is not accurately recovered from the detection signal unless the antenna response term A(ν) is known over the frequency range of operation. According to a preferred embodiment of the invention, therefore, the antenna 104 has an antenna response which is substantially constant across the frequency range of operation. If an antenna response A(ν) is known (such as when the antenna response is substantially constant) then the reflectivity Γ(ν) of a shoe may be recovered through a process of deconvolution. In the frequency domain the process of deconvolution takes the form of division of the detection signal S(ν) by the antenna response A(ν).

A variable antenna response may be accounted for by placing a reference target, which is a substantially perfect reflector at a fixed distance from an antenna, where a substantially perfect reflector is a reflector which substantially reflects all radiation incident upon it. The detection signal at each frequency of operation is then measured and stored as a reference antenna response. A reference antenna response may be measured and stored for each antenna position. Detection signals later measured during shoe scanning are then divided by the reference antenna response.

In the time domain, the process of deconvolution takes the form of convolution of the received signal S(t) with a signal q(t) which satisfies the relation,

ℑ⁻¹{A(ν)}\textcircled{×}q(t)=const. (4)

As described above, the signal reflected from different depths within a shoe may be determined by emitting pulses of radiation and measuring a detection signal in the time domain. In order to resolve layers of a shoe having depths<1 cm, the pulse width in the time domain must be very narrow (approximately 67 femto seconds) and must still carry sufficient energy that a detection signal can be accurately measured. Such narrow pulse widths may be difficult to realise.

The signal reflected from different depths within a shoe may alternatively be determined by emitting radiation which is swept across a wide frequency band. A detection signal may be measured at each frequency. For example, the frequency of emitted radiation may be swept across a frequency band which may fall within the range 0.1 GHz-300 GHz. It has been found that radiation in this frequency range propagates through typical shoe materials without being strongly attenuated. Detection signals of sufficient magnitude may therefore be measured with a relatively low power of emitted radiation. The power of the emitted radiation may be less than 1 mW and therefore does not pose a health risk.

In some embodiments of the invention, emitted radiation is stepped through N discrete frequency steps each separated by a frequency change Δν. The frequency at each step is given by mΔν where m=0,1,2, . . . N−1. A detection signal Sₘ is measured at each step and may be given by,

Sₘ=AₘΓₘexp(−i4πmΔνz₀/c) (5)

where Aₘ is the antenna response and Γₘ the reflectivity of the shoe at the frequency mΔν. At frequencies at which an antenna does not emit or receive radiation Aₘ=0.

The analogous detection signal in the time domain Sₙ is synthesised by applying a discrete inverse Fourier transform to the detection signals in the frequency domain Sₘ such that,

$${S}_{n} = \frac{1}{N} {\sum }_{m = 0}^{N - 1} {S}_{m} exp ( i 2 π mn / N ) \qquad ( 6 )$$

where n=0,1,2, . . . N−1. The synthesised detection signal in the time domain Sₙ is equivalent to a detection signal measured at N time steps after a narrow pulse of radiation is emitted. The separation between synthesised time steps Δt, and hence the resolution in the time domain, is given by,

$$Δ t = \frac{1}{( N - 1 ) Δ v} \qquad ( 7 )$$

The resolution of the shoe scanner 100 in the time domain is limited by the frequency bandwidth (BW) over which the antenna response A(ν) is greater than zero and either substantially constant with frequency or known to a high enough accuracy to correct the detection signals such that,

$$Δ t \geq \frac{1}{BW} \qquad ( 8 )$$

In general the spatial separation Δz of objects at different depths in a shoe resolvable by the shoe scanner 100 is limited such that,

$$Δ z \geq \frac{c}{2 nBW} \qquad ( 9 )$$

where n is the real part of the refractive index of the material through which the radiation passes. In order to resolve the signal reflected from different depths in a shoe at a high spatial resolution the bandwidth BW is therefore preferably large. The maximum distance range obtainable by the shoe scanner 100 can be increased by decreasing Δν.

The actual resolution of the shoe scanner 100 may degrade according to the precision and stability of the frequency sweep. The overall quality of an image obtained with the shoe scanner 100 depends on the spatial resolution of the scan, the width of the emitted beam of radiation and the absorption and scattering properties of the scanned object.

At each position of the antenna 104, the frequency of emitted radiation may be swept continuously or in discrete steps. According to a preferred embodiment of the invention both the amplitude and the phase of the reflected radiation relative to the emitted radiation is measured. Measurement of the amplitude and the phase of reflected radiation may be performed using homodyne or superheterodyne techniques. Measurement of the amplitude and the phase of reflected radiation may be used to determine both the real and imaginary parts of a complex detection signal. Alternatively, if only the real component of the detection signal is measured then the imaginary component may be determined by using the Hilbert transform.

A detection signal may be corrected for background signals (such as reflections from the surface 103 on which a shoe is positioned) by measuring and storing background detection signals at each frequency of operation with no shoe in place. Background detection signals may be measured and stored at each antenna position, and may be determined in the frequency domain at each frequency of operation. Alternatively, background detection signals may be determined in the time domain at different times after a pulse of radiation is emitted.

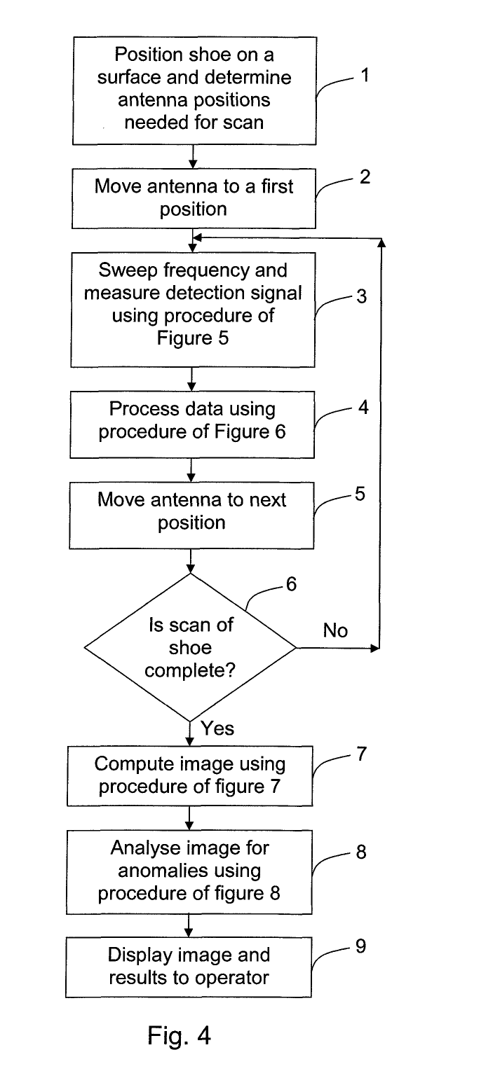

Processing carried out by the controller 200 to scan a shoe according to an embodiment of the invention is now described with reference to the shoe scanner 100 of FIG. 1 and the flowcharts of FIGS. 4 to 8. Referring to FIG. 4, at step 1 a shoe is positioned on the surface 103 overlying the shoe scanner 100. As discussed above, the shoe may be worn or may be positioned on the surface overlying the shoe scanner after removal by the wearer. The positions at which the antenna 104 should scan the shoe are then determined. The position of the shoe at which the shoe should be placed may be predetermined, for example, by marking a position on the surface at which the shoe should be placed. The exact position of the shoe on the surface 103 may be determined by any appropriate means. For example the exact shoe position may be determined by pressure sensors on or below the surface, by performing a raster scan with the antenna over a predetermined area, or by taking an image from above the surface and using object recognition algorithms.

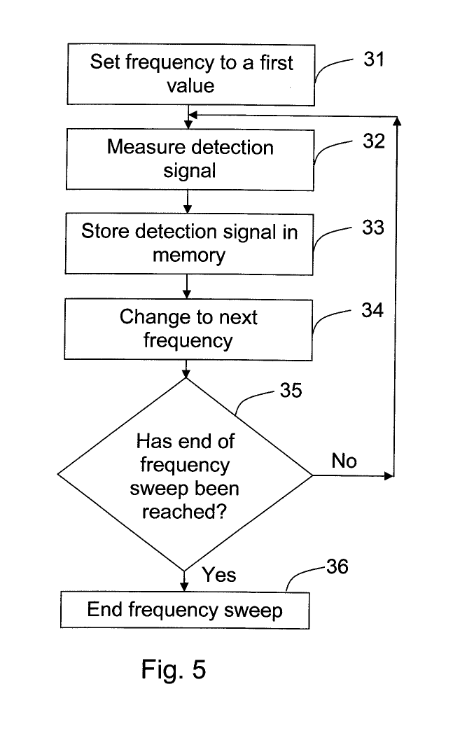

At step 2 the antenna 104 is moved to a first position. At step 3 the frequency of radiation emitted by the antenna 104 is swept and a detection signal measured using processing now described with reference to FIG. 5. At step 31, the frequency of emitted radiation is set to a first value and radiation emitted. At step 32 the detection signal is measured using the methods described above. The measured value is stored in a memory of the computer 208 at step 33. At step 34 the next frequency at which radiation is emitted is selected. At step 35 it is determined whether the end of a predetermined frequency sweep has been reached. If the end of the frequency sweep has not been reached then processing passes back to step 32. On the other hand, if the end of the frequency sweep has been reached, processing passes from step 35 to end at step 36. In an embodiment of the invention, at each position of the antenna, the frequency of radiation emitted by the antenna is swept from 15-40 GHz in 1024 discrete steps. At each frequency step and each antenna position radiation is emitted for approximately 0.5 ms and the detection signal is stored in memory.

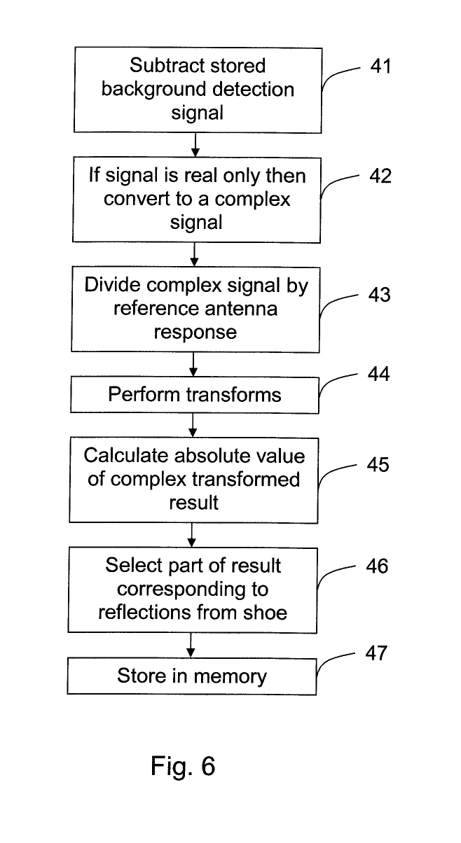

Referring again to FIG. 4, processing proceeds from step 3 to step 4, at which the detection signals stored in memory during step 3 are processed, as now described with reference to FIG. 6. At step 41 a predetermined and stored background detection signal is subtracted from the detection signals. If only the real part of the detection signals are available then the detection signals are converted to complex detection signals using the Hilbert transform, as described above, at step 42. The complex detection signals are then divided by a predetermined and stored reference antenna response at step 43. At step 44 the complex detection signals are transformed into the time domain. The transformation at step 44 may be by way of, for example, a discrete inverse Fourier transform or by way of a chirp transform.

The complex detection signals may further be transformed to a spatial domain by using the time domain to calculate the depth within the shoe from which the detection signals were reflected. The time domain represents the time taken for a pulse of radiation to travel from the antenna 104, be reflected from a depth within the shoe and travel back to the antenna 104. If it is assumed that the time taken for the pulse of radiation to travel from the antenna to the reflection depth is equal to the time taken for the pulse of radiation to travel from the reflection depth back to the antenna then an effective depth at which the radiation was reflected may be calculated by dividing the time domain by two and multiplying the time domain by the speed of light. The effective depth is equal to the true depth multiplied by the real part of the refractive index of the material through which the radiation has passed. At step 45 the absolute values of the complex transformed detection signals are calculated. At step 46 the portions of the transformed signals which correspond to reflection from the shoe are selected, and stored in memory at step 47.

Referring again to FIG. 4, processing passes to step 5 at which the antenna 104 is moved to the next position from the positions determined at step 1. At step 6 it is determined whether the depth of the shoe has been scanned, and the data processed, at each of the antenna positions determined in step 1. If it is determined that the depth of the shoe has not been scanned and the data processed at each of the antenna positions determined in step 1 then processing is passed back to step 3. The shoe may be scanned at positions along the length of the shoe. The antenna 104 may then be displaced by a series of distances across the width of the shoe and the shoe scanned again at positions along the length of the shoe. When it is determined that the depth of the shoe has been scanned and the data processed at each of the antenna positions determined in step 1 then processing passes to step 7. According to an embodiment of the invention the antenna 104 is moved along the length of a shoe in, typically, 33 steps with the distance between steps of the antenna of 10 mm.

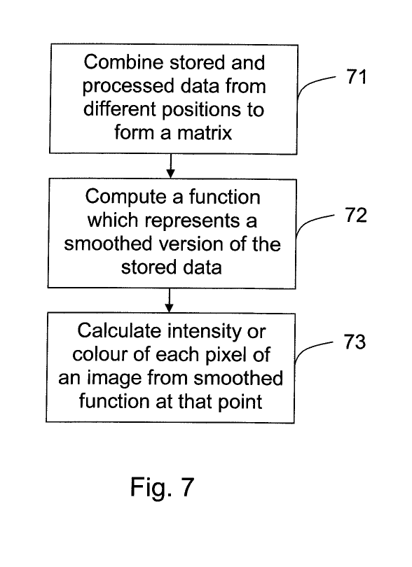

The processing of step 7 is now described in detail with reference to FIG. 7. At step 71 the data stored in memory at step 47 of FIG. 6 for each antenna position is combined and stored in a matrix. The positions in the matrix correspond to positions within the shoe and the matrix may be two or three dimensional, depending on how many dimensions over which the shoe was scanned. At step 72 a function is computed which represents a version of the data stored in the matrix, which may be smoothed if required, by way of linear interpolation or otherwise. The function may be a two or three-dimensional function depending upon whether the antenna 104 is moved in one or two dimensions beneath the shoe. At step 73 an intensity or colour value is determined for each pixel of an image according to the function computed at step 72. The image may represent a view of a shoe from a single angle. Alternatively the signal reflected from positions throughout the three-dimensional shoe may be combined into a three-dimensional representation of the shoe. A three-dimensional representation may, for example, be a two dimensional image displayed on the user interface 209 corresponding to a view of the shoe from a particular angle. An operator may then be able to rotate the image so as to display an image of the shoe viewed from a different angle.

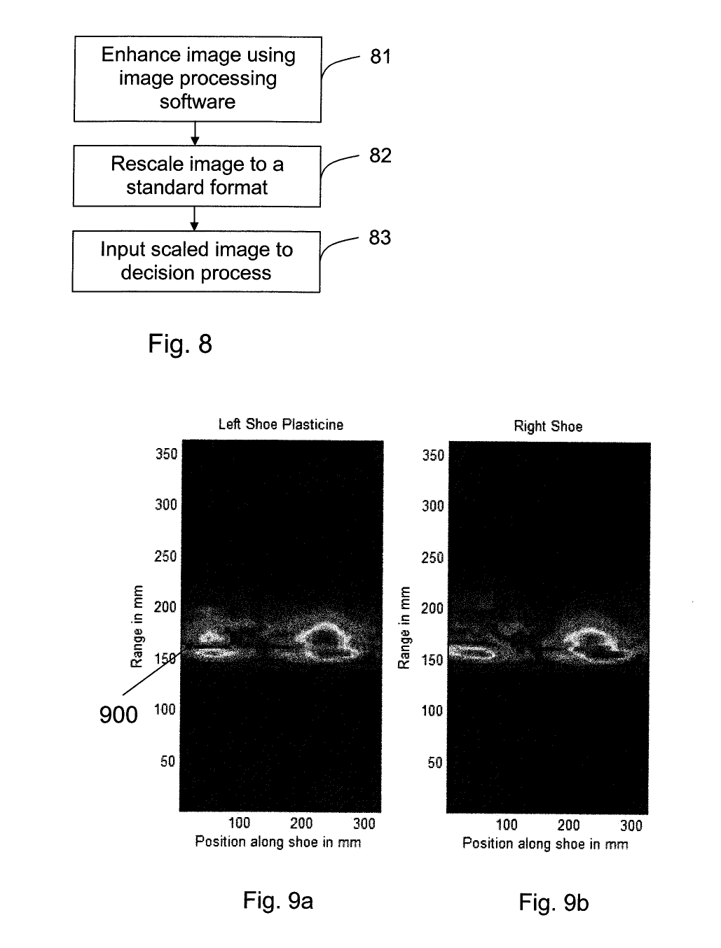

Referring again to FIG. 4, at step 8 the image computed at step 7 is analysed using the processing shown in FIG. 8. At step 81 the image computed at step 7 is enhanced using image processing software. Methods to enhance images numerically are well known in the art and may include emphasising boundaries between different features in the image. At step 82 methods of recognising standard shapes and sizes of footwear may be employed to rescale the image to a standard format. Recognition of footwear at step 82 may be by way of any appropriate image processing/object detection algorithms as will readily appreciated by those skilled in the art.

At step 83 the image is passed to a decision process which determines whether the shoe shows signs of containing one or more concealed objects. The decision process may comprise visual analysis by an operator to identify regions of an image which indicate the presence of a concealed object. Additionally, or alternatively the decision process may comprise performing one or more artificial intelligence procedures on an image.

One such artificial intelligence procedure may comprise inputting the image to an artificial neural network for analysis, where the artificial neural network is trained with sample sets comprising images of shoes with and without concealed objects. The neural network training set may additionally comprise information related to the type of shoe. It will be appreciated that any appropriate neural network may be used. For example, the neural network may be a feed forward neural network such as a multi-layer perceptron, or a recurrent neural network. The trained artificial neural network may then analyse an image of a shoe and determine whether the shoe shows any signs of containing concealed objects.

The decision process of step 83 may additionally or alternatively include comparing images of both shoes of a pair. For example, both shoes of a pair may be scanned sequentially using a single shoe scanner or scanned simultaneously using multiple shoe scanners. Any differences between the images of both shoes of a pair may indicate the presence of concealed objects in one or both of the shoes. Additionally or alternatively, the decision process may include comparing an image of a shoe with an expected image for a similar type of shoe, which may have been previously determined and stored in a library. For example, a plurality of images for standard shoe types (e.g. sports shoes, high-healed shoes, etc), and/or popular brands and/or specific models of shoe may be stored at the computer 208 for comparison with a scanned shoe. In some embodiments of the invention, data may be received from shoe manufactures providing scans of shoes for use in comparing with scanned shoes. The type of shoe being scanned may be determined by an operator of the scanner 100, or may be determined automatically. For example, image recognition software may be utilised to process an image obtained from a camera above the surface 103 to identify a model of shoe placed on the surface 103. For example, images of the shoe to be scanned may be compared with a database of shoe images.

To identify suitable information from information stored in a database, optical images of a shoe to be scanned may be obtained from various aspects, in order to identify indicative features of the shoe. For example, images may be taken from above, and from the sides of a shoe to be scanned. Obtained images may then be processed using any appropriate image processing techniques as required to provide resulting images suitable for comparison with information/images stored in the database. As examples only, techniques such as histogram equalisation, edge detection, and template matching may be appropriate to determine a shoe type, and shoe parameters such as heel and sole depth and position.

Comparisons of data obtained by scanning shoes with data stored in a library may be by way of, for example, image subtraction. That is, images selected from, or generated from data, stored in a library may be subtracted from images obtained by scanning. In this case, remaining portions of the images obtained by scanning (i.e. portions of the images obtained by scanning not in the library images) may indicate the presence of concealed material or objects. Additionally or alternatively, a comparison may be made with measured optical depths of various features within soles or heels of the shoes being screened, with reference to reference optical depths for those features. For example, suitable features include, but are not limited to, the interface between a shoe and a sole of the wearer's foot. As a more general example, regions of interface between dielectric media that results in reflection of microwave radiation energy, provide suitable features for such comparisons.

Objects or material may be most likely to be concealed in a heal, or thick sole, of a shoe. As such, in some embodiments of the invention, images of shoe under investigation (obtained, for example, by a side-facing camera) may be used to determine a depth of a heal or sole. Results of scanning the shoes using the method described above may then be compared with expected, or previously observed, responses for heals/soles of the determined depth.

In some embodiments of the invention, one or more of the approaches to determining whether a shoe contains concealed objects or material may be combined or conditionally combined. For example, in some embodiments a comparison of each shoe in a pair of shoes may be initially performed. Where such an initial test indicates the presence of concealed objects/material, further automated tests may be deemed unnecessary (e.g. for immediate manual inspection may be suggested). Where an initial test does not reveal the presence of concealed material, further automated tests may be performed. For example, further processing may be based upon a determination as to whether an exact model of the shoe has been/could be ascertained. Where an exact model can be ascertained, processing may be based upon information for that model, while if an exact model of the shoe cannot be ascertained, further processing may be based upon a, general, type of shoe, as described above. Where no information can be determined for useful automated processing, manual inspection may be recommended.

Referring again to FIG. 4, at step 9 an image of a shoe and the result of the decision process is displayed to an operator. This allows the operator to evaluate the outcome of the decision process and if necessary further visually analyse the image. In the event that a shoe shows signs of containing concealed objects, an operator may instruct that a shoe is subjected to further scanning such as x-ray scanning of the shoe.

FIGS. 9a and 9b each show an image produced by scanning, respective, a left shoe and a right shoe of a pair of shoes in accordance with the present invention. The left shoe (from which the image of FIG. 9a was produced) was modified to conceal a small block of plastic explosive stimulant in a heel of the shoe, while the right shoe (from which the image of FIG. 9b was produced) was unmodified. Area 900 in FIG. 9a clearly shows the presence the concealment within the left shoe when compared with the equivalent position in FIG. 9b. In particular, FIG. 9a clearly shows an area of substantial reflection at a depth of approximately 170 mm into the heel of the left shoe, while no such reflections are present at the same depth in FIG. 9b.

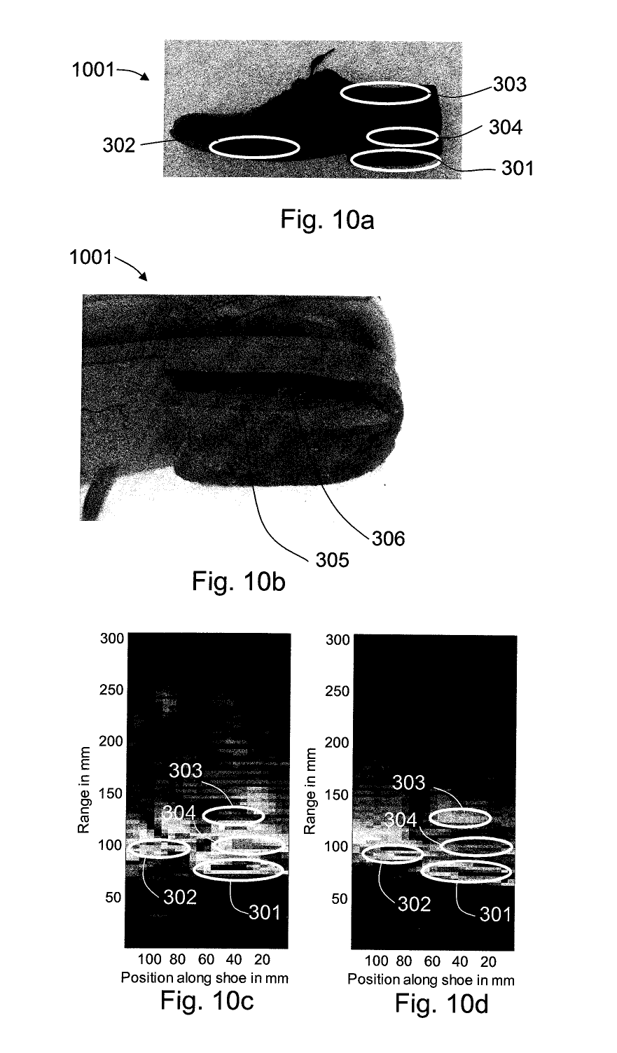

FIG. 10a shows a photograph of a shoe 1001. FIG. 10b shows a photograph of the shoe 1001 with a lower portion 305 of a heel of the shoe partially removed from the shoe. An imitation explosive material is inserted into a honeycomb structure 306 in an upper portion of the heel of the shoe 1001. FIGS. 10c and 10d show images produced by scanning the shoe 1001 as described above. The image in FIG. 10c was produced by scanning the shoe 1001 before the imitation explosive material was inserted into the shoe. The image in FIG. 10d was produced by scanning the shoe 1001 after the imitation explosive material was inserted in the shoe 1001.

FIGS. 10c and 10d both show regions of strong reflected signal from a lower edge 301 of the heel and a front portion 302 of a sole of the shoe 1001. A marked area 304 of FIG. 10c shows increased signal reflections compared to a marked area 304 of FIG. 10d, the marked areas 304 corresponding to the region 305 of FIG. 10c in which the imitation explosive material was inserted into the shoe 1001. FIG. 10c also shows decreased signal reflections compared to FIG. 10d from a region 303, above the inserted imitation explosive material. Decreased signal reflections from the region 303 in FIG. 10c is due to the fact that the imitation explosive material reflects or absorbs a significant portion of the radiation emitted by antenna 104, thereby reducing the intensity of radiation which penetrates to region 303 for reflection back to the shoe scanner 100. A comparison of the images in FIGS. 10c and 10d therefore reveals the presence of a concealed object in the shoe 1001.

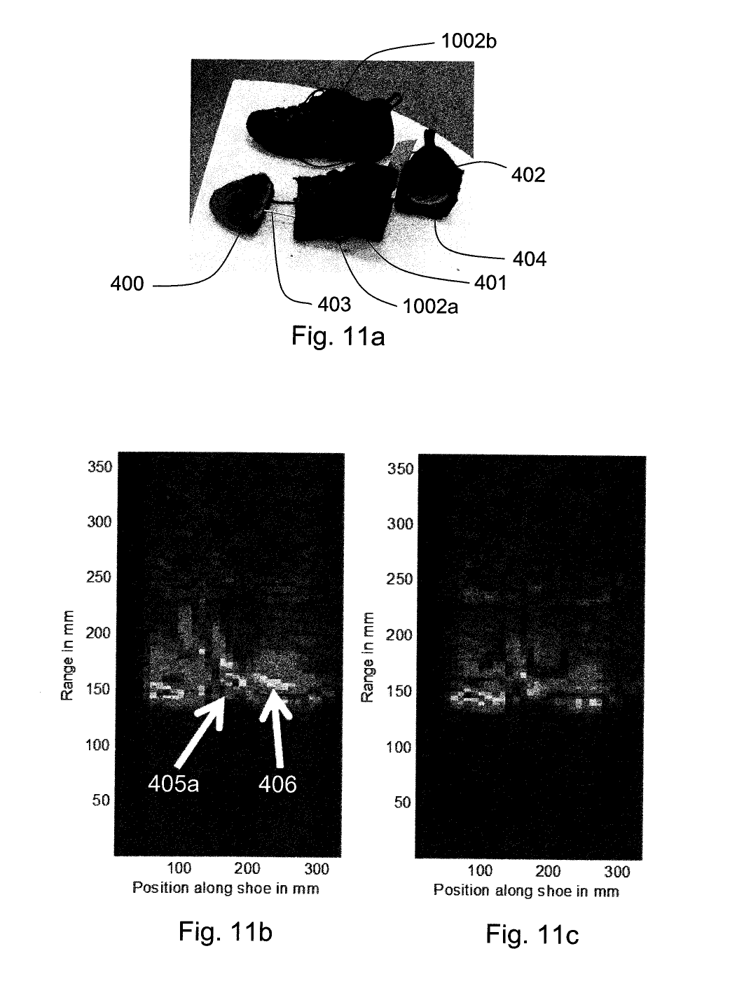

FIG. 11a shows a photograph of a right shoe 1002a and a left shoe 1002b. The right shoe 1002a has been sliced into three sections 400, 401, 402 and a metal rod 403 (simulating, for example, a detonator) inserted into the shoe 1002a between the sections 400 and 401. An imitation explosive material 404 is also inserted into a heel of the right shoe 1002a in section 402. FIGS. 11b and 11c show images of shoes 1002a and 1002b respectively, both produced by scanning the shoes according to an embodiment of the invention. A comparison of FIGS. 11b and 11c clearly indicates, at region 405, the presence of the material 404, and at region 406 the presence of the rod 403. In particular, region 406 has an increased reflected signal at a depth of approximately 150 mm compared to the equivalent region of FIG. 11b, due to the presence of the metal rod 403. Region 405 has an increased reflected signal at a depth of approximately 150 mm compared to the equivalent region of FIG. 11b, due to the presence of the imitation explosive material 404. A comparison of the images in FIGS. 10b and 10c therefore reveals the presence of concealed objects in right shoe 1002a.

Whilst the invention has been described in relation to its use in security screening, the invention may also find applications in other fields such as shoe retail and leisure industries. Modern sports shoes often have complex structures and contain air-filled cavities in the sole and/or the heel of the shoe in order to cushion impact forces subjected on the foot during running or other sports activities. After a period of use the cavities in a shoe break down and the performance of the shoe is reduced. After such a time a shoe may need replacing. Reduced performance of a shoe is often not apparent through visual inspection of the shoe alone. Detecting indicators of reduced performance of a shoe by scanning the shoe using embodiments of the present invention provides an efficient and advantageous way to detect shoe deterioration.

The invention may additionally be used to model footwear, for example to determine stability and wear characteristics. Such modeling may be used to develop, for example, improved sporting footwear, military footwear, etc. based upon wear and stability characteristics.

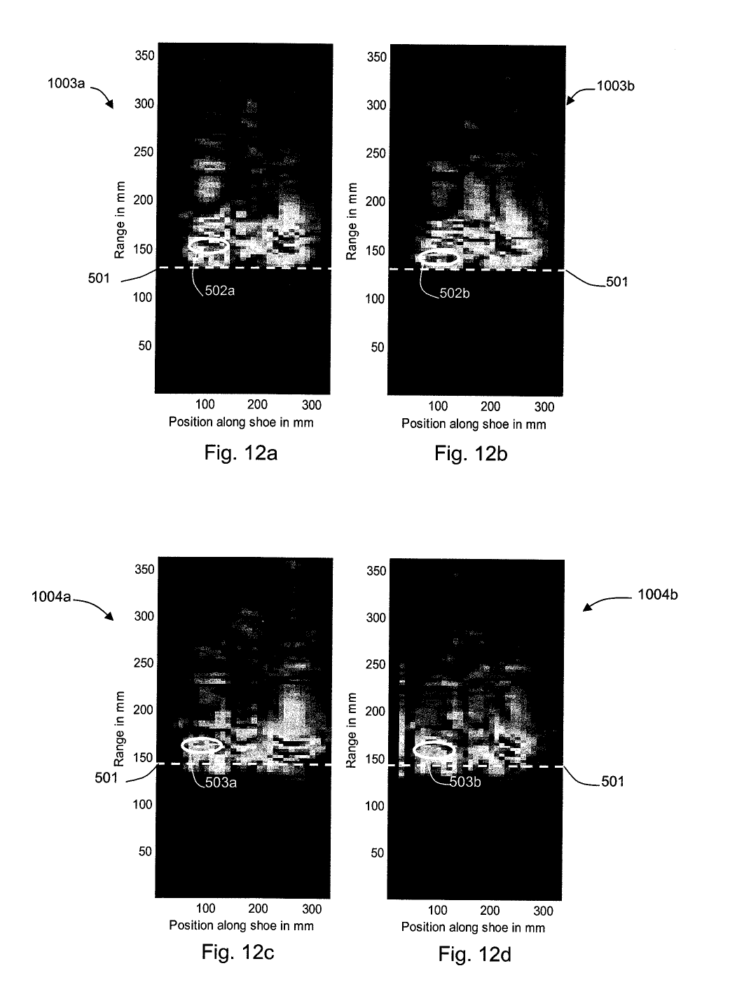

FIGS. 12a-12d show images of shoes 1003a, 1003b, 1004a and 1004b respectively, produced by scanning the shoes according to the present invention. A right shoe 1003a and a left shoe 1003b are a pair of sports shoes which have been worn for a period of months, while a right shoe 1004a and a left shoe 1004b are a pair of sports shoes which are similar to shoes 1003a and 1003b but are unworn. The images in FIGS. 12a-12d were produced by scanning the shoes under similar conditions with feet in the shoes, applying similar downward pressures to the shoes. A line 501 in each image indicates the location of a surface on which the shoes are positioned. Reflected signals corresponding to feet and insides of soles of shoes 1003a, 1003b, 1004a and 1004b can be seen to originate from a greater distance above line 501 in FIGS. 12c and 12d than in FIGS. 12a and 12b, indicating that air cushions in the soles and heels of shoes 1004a and 1004b provide a larger cushioning force than air cushions in the soles and heels of shoes 1003a and 1003b. It may therefore be inferred that shoes 1003a and 1003b have a reduced cushioning performance compared to shoes 1004a and 1004d.

Regions 502a and 502b in FIGS. 12a and 12b correspond to reflected signals from the heels of shoes 1003a and 1003b respectively. Regions 502a and 502b show a larger reflected signal than corresponding regions 503a and 503b in FIGS. 12c and 12d. Larger reflected signals from the soles of shoes 1003a and 1003b indicate a breakdown or modification of the material in the soles of shoes 1003a and 1003b. A comparison of FIGS. 12a and 12b with FIGS. 12c and 12d therefore indicates that shoes 1003a and 1003b are worn and have a reduced performance compared to shoes 1004a and 1004b.

Although embodiments of the invention have been described as using a single antenna which may be moved along the length and across the width of a shoe, it should be understood that the invention is not to be limited by such an arrangement. Alternative methods may be employed to construct images of reflected signal from different depths in a shoe.

Additionally, while it described above that the antenna is positioned below a shoe to be scanned, the antenna may be positioned so that a shoe is scanned from the side or from the top of the shoe.

A plurality of antennas may be positioned in a line or matrix formation. The positions of the plurality of antennas may be fixed and each of the plurality of antennas sequentially activated to emit radiation and detect a signal. The plurality of antennas may be sequentially activated by controlling power supplied to them with a plurality of electronic switches. Signals detected at the plurality of antennas may be combined to construct an image of signal reflected from different depths within a shoe without moving the antennas in one or more directions.

A plurality of antennas or a single movable antenna may be used to emit a steerable beam of radiation through the technique of Synthetic Aperture Radar. The technique of Synthetic Aperture Radar may allow for a shoe to be scanned at a wide range of angles, using a low gain antenna whilst maintaining a high spatial resolution. According to the technique of Synthetic Aperture Radar an effective focused spot of a steerable radiation beam is moved around a shoe. Signals detected at a plurality of antennas or a plurality of antenna positions may be measured and processed by software to construct an image of signals reflected from different positions in a shoe.

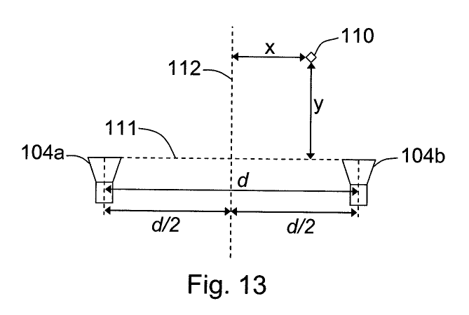

Signals detected at two or more antennas may be simultaneously measured and combined into a single image. FIG. 13 schematically shows a portion of a shoe scanner according to an embodiment of the invention having two antennas. Antennas 104a and 104b are separated from each other by a distance d. A point 110 lies at a distance y from a line 111 which joins antennas 104a and 104b. Point 110 is at a distance x from a line 112 which is perpendicular to the line 111 and crosses the line 111 at a point which is equidistant from antennas 104a and 104b. Point 110 may be a point which strongly reflects radiation. Radiation reflected from point 110 will appear as a signal S₁(L₁) at antenna 104a reflected from a distance L₁ from antenna 104a where

L₁=\sqrt{y²+(x+d/2)²} (10)

Radiation reflected from point 110 will appear as a signal S₂(L₂) at antenna 104b reflected from a distance L₂ from antenna 104b where

L₂=\sqrt{y²+(x−d/2)²} (11)

The product of signals S₁ and S₂ from all distances may then be used to form an image on the axes Y=(L₁+L₂)/2 and X=(L₁−L₂)/2. Such an image would appear as an image of signal reflected from different positions in a shoe but would appear spatially distorted when compared to an analogous image plotted on standard x, y axes. The image may be corrected by appropriate transformation of the image axes to be plotted on standard X, Y axes using expressions derived from equations (12) and (13) derived from equations (10) and (11) above.

x=2XY/d (12)

y²=X²+Y²−d²/4−x² (13)

An analogous method may be used to combine detection signals measured simultaneously at more than two antennas.

A rotatable paraboloidal mirror may be used to focus and scan a beam of radiation across a shoe and a detected signal measured at one or more antennas. Alternatively a radiation beam may be scanned across a shoe by tilting one or more antennas or mechanically moving or tilting one or more mirrors or prisms. A beam of radiation may be modified by optical components such as one or more lenses and/or one or more curved mirrors in order to adjust the spatial resolution of a shoe scanner.

It will be appreciated that while the above description describes the processing of image data obtained by the shoe scanner 100, data obtained by the shoe scanner 100 need not be converted into images prior to processing. That is, raw data obtained by the shoe scanner 100 may be processed directly (for example by a neural network as described above), without interpreting such data as image data.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the appended claims.

1. A method of scanning a shoe, comprising:
directing from a source at least one first signal at the shoe, the at least one first signal comprising substantially millimetre and/or microwave radiation;
receiving at one or more receivers a plurality of second signals, the plurality of second signals comprising reflections of said at least one first signal from different positions with said shoe;
processing each of the second signals to determine a plurality of reflection positions within the shoe;
processing said plurality of second signals and reflection positions to generate second data, the second data indicating a composition of the shoe.

2. A method according to claim 1, further comprising:
processing said second data to generate an indication of whether the shoe comprises concealed material.

3. A method according to claim 1, further comprising:
processing said second data to generate an indication of a cushioning ability of the shoe.

4. A method according to claim 1, wherein processing said second data comprises comparing said second data to first reference data.

5. A method according to claim 4, wherein said first reference data comprises data indicating a composition of a reference shoe.

6. A method according to claim 5, wherein said reference shoe does not comprise concealed material.

7. A method according to claim 2, wherein processing said second data comprises scanning a second shoe to generate third data indicating a composition of said second shoe and comparing said second data with said third data.

8. A method according to claim 7, further comprising outputting an indication that one of said first or second shoes comprises concealed material if said comparison indicates a difference in composition between said second and third data.

9. A method according to claim 2, wherein processing said second data comprises generating an image from said second data and outputting said image on a display device.

10. A method according to claim 1, wherein directing at least one first signal at said shoe comprises directing a pulse of radiation at said shoe.

11. A method according to claim 10, wherein each of said second signals is a reflection of a portion of said pulse and each of said second signals is received at a different time.

12. A method according to claim 1, wherein directing at least one first signal at said shoe comprises directing radiation having a plurality of frequencies at said shoe such that the plurality of said second signals comprises radiation having a plurality of frequencies.

13. A method according to claim 12, wherein generating said second data comprises transforming said second signals into a time domain.

14. A method according to claim 13, wherein transforming said second signals into a time domain comprises applying one of an inverse Fourier transform or a chirp transform to said second signals.

15. A method according to claim 2, wherein processing said second data comprises applying said second data as input to a neural network.

16. A method according to claim 1, wherein generating said plurality of second signals comprises receiving at the one or more receivers a plurality of third signals, said third signals being reflections of at least one fourth signal from a surface between said source and said shoe; and
wherein processing said plurality of second signals and reflection positions comprises substantially removing said third signals from said second signals.

17. A method according to claim 16, wherein removing said third signals comprises subtracting a predetermined reference signal from said second signals.

18. A method according to claim 1, wherein said radiation is directed at said shoe from beneath said shoe.

19. A method according to claim 1, wherein directing radiation at said shoe comprises directing radiation from a plurality of locations with respect to said shoe.

20. Apparatus for scanning a shoe, comprising:
a source arranged to direct at least one first signal comprising substantially millimetre and/or microwave radiation at a shoe;
one or more receivers arranged to receive a plurality of second signals comprising reflections of said at least one first signal from different positions with said shoe;
a controller arranged to process each of the second signals to determine a plurality of reflection positions within said shoe and process said plurality of second signals and reflection positions to generate second data indicating a composition of said shoe.

21. Apparatus according to claim 20, wherein said source is mounted on a carriage arranged to move said source between a plurality of locations with respect to said shoe.

22. Apparatus according to claim 20, further comprising:
a surface for receipt of a shoe, said surface being substantially transparent to millimetre and/or microwave radiation.

23. Apparatus according to claim 22, wherein said surface comprises a plurality of slats, extending in a direction substantially parallel to a direction in which shoes are to be scanned.

24. Apparatus according to claim 20, wherein the source is a horn antenna.

25. Apparatus according to claim 22, wherein said source is positioned at a distance of 10 mm from said surface.

26. Apparatus according to claim 20, wherein the controller is further arranged to process said second data to generate an indication of whether the shoe comprises concealed material.

27. Apparatus according to claim 20, wherein the controller is further arranged to process said second data to generate an indication of a cushioning ability of the shoe.

28. Apparatus according to claim 20, wherein processing said second data comprises comparing said second data to first reference data.

29. Apparatus according to claim 28, wherein said first reference data comprises data indicating a composition of a reference shoe.

30. Apparatus according to claim 29, wherein said reference shoe does not comprise concealed material.

31. Apparatus according to claim 26, wherein said processor is arranged to scan a second shoe to generate third data indicating a composition of said second shoe and compare said second data with said third data.

32. Apparatus according to claim 31, wherein said processor is further arranged to output an indication that one of said first or second shoes comprises concealed material if said comparison indicates a difference in composition between said second and third data.

33. Apparatus according to claim 26, wherein said processor is arranged to generate an image from said second data and outputting said image on a display device.

34. Apparatus according to claim 20, wherein said source is arranged to direct at least one first signal at said shoe by directing a pulse of radiation at said shoe.

35. Apparatus according to claim 34, wherein each of said second signals is a reflection of a portion of said pulse and each of said second signals is received at a different time.

36. Apparatus according to claim 20, wherein said source directing at least one first signal at said shoe comprises directing radiation having a plurality of frequencies at said shoe such that the plurality of said second signals comprises radiation having a plurality of frequencies.

37. Apparatus according to claim 36, wherein said controller is adapted to generate said second data by transforming said second signals into a time domain.

38. Apparatus according to claim 37, wherein said controller is adapted to transform said second signals into a time domain by applying one of an inverse Fourier transform or a chirp transform to said second signals.

39. Apparatus according to claim 26, wherein the controller is adapted to process said second data by applying said second data as input to a neural network.

40. Apparatus according to claim 20, wherein the one or more receivers are adapted to receive a plurality of third signals, said third signals being reflections of said at least one fourth signal from a surface between said source and said shoe; and
wherein the controller is adapted to process said plurality of second signals and reflection positions by substantially removing said third signals from said second signals.

41. Apparatus according to claim 40, wherein the controller is adapted to remove said third signals by subtracting a predetermined reference signal from said second signals.

42. Apparatus according to claim 20, wherein said source is adapted to direct radiation at said shoe from beneath said shoe.

43. Apparatus according to claim 20, wherein said source is adapted to direct radiation at said shoe by directing radiation from a plurality of locations with respect to said shoe.

44. A non-transitory computer readable medium carrying a program comprising computer readable instructions arranged to cause a computer to carry out a method according to claim 1.

45. A computer apparatus for scanning a shoe, comprising:
a memory storing processor readable instructions; and
a processor arranged to read and execute instructions stored in said memory;
wherein said processor readable instructions comprise instructions arranged to control the computer to carry out a method according to claim 1.
